(19) United States
(12) Patent Application Publication
(10) Pub. No.: US 2019/0130900 A1
(43) Pub. Date: May 2, 2019

(54) VOICE INTERACTIVE DEVICE AND VOICE INTERACTIVE METHOD USING THE SAME

(71) Applicant: INSTITUTE FOR INFORMATION INDUSTRY, Taipei City (TW)

(72) Inventors: Cheng-Hung Tsai, Tainan City (TW); Sun-Wei Liu, New Taipei City (TW); Zhi-Guo Zhu, Taipei City (TW); Tsun Ku, Taipei City (TW)

(73) Assignee: INSTITUTE FOR INFORMATION INDUSTRY, Taipei City (TW)

(21) Appl. No.: 15/830,390

(22) Filed: Dec. 4, 2017

(30) Foreign Application Priority Data
Nov. 1, 2017 (TW) 106137827

(51) Int. Cl. G10L 15/18; G10L 15/22; G10L 25/63; G10L 13/00

(52) U.S. Cl. CPC G10L 15/1815; G10L 15/22; G10L 2015/088; G10L 13/00; G10L 2015/223; G10L 25/63

(57) ABSTRACT

A voice interactive device includes a semantic analyzing module, a tone analyzing module, a speaker classification determining module and a dialogue sentence database. The semantic analyzing module is configured to analyze a semantic meaning of speaking sentence from a speaker. The tone analyzing module is configured to analyze a tone of the speaking sentence. The speaker classification determining module is configured to determine that the speaker belongs to one of a plurality of speaker classification types according to the semantic meaning and the tone. The dialogue sentence database stores a plurality of relationships between speaker classifications and response sentences. The dialogue sentence generating module is configured to generate a response sentence corresponding to the speaker according to the relationships between speaker classifications and response sentences. The voice generator is configured to output a response voice of the response sentence.

This application claims the benefit of Taiwan application Serial No. 106137827, filed Nov. 1, 2017, the disclosure of which is incorporated by reference herein in its entirety.

### TECHNICAL FIELD

The disclosure relates in general to a interactive device and a interactive method, and more particularly to a voice interactive device and a voice interactive method using the same.

### BACKGROUND

In general, store provides an information machine, and consumers may inquire information about the products they need and information about the products, such as price, company brand, stock, etc. through the information machine. However, most of the information machines interact with consumers passively, and most of them require consumers to input search condition manually or read bar codes through bar code readers. As a result, the consumers are not willing to use the information machines frequently, which is not helpful to increase sale. Therefore, it is one of the directions for those skills in the art to submit a new voice interactive device and its voice interactive method for improving the aforementioned problems.

### SUMMARY

The disclosure is directed to a voice interactive device and a voice interactive device using the same to solve the above problem.

According to one embodiment, a voice interactive device is provided. The voice interactive device includes a semantic analyzing module, a tone analyzing module, a speaker classification determining module and a dialogue sentence database. The semantic analyzing module is configured to analyze a semantic meaning of speaking sentence from a speaker. The tone analyzing module is configured to analyze a tone of the speaking sentence. The speaker classification determining module is configured to determine that the speaker belongs to one of a plurality of speaker classification types according to the semantic meaning and the tone. The dialogue sentence database stores a plurality of relationships between speaker classifications and response sentences. The dialogue sentence generating module is configured to generate a response sentence corresponding to the speaker classification type of the speaker according to the relationships between speaker classifications and response sentences. The voice generator is configured to output a response voice of the response sentence.

According to another embodiment, a voice interactive method is provided. The voice interactive method includes the following steps. a semantic meaning of speaking sentence from a speaker is analyzed; a tone of the speaking sentence is analyzed; according to the semantic meaning and the tone, the speak belongs to one of a plurality of speaker classification types is determined; according to the relationships between the speaker classifications and response sentences stored in dialogue sentence database, a response sentence corresponding to the speaker is generated; and a response voice of the response sentence is outputted.

### BRIEF DESCRIPTION OF THE DRAWINGS

FIG. 1A illustrates a block diagram of a voice interactive device according to an embodiment of the present invention;

FIG. 1B illustrates a block diagram of the voice interactive device according to another embodiment of the present invention;

FIG. 2 illustrates a diagram of corresponding relationships among the keyword, the emotion, the speaker classification type and the response sentence;

FIG. 3 illustrates a flowchart of a voice interactive process of FIG. 1B; and

FIGS. 4A and 4B illustrate diagrams of voice training procedure of a training process of the voice interactive device according to the present embodiment of the present invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

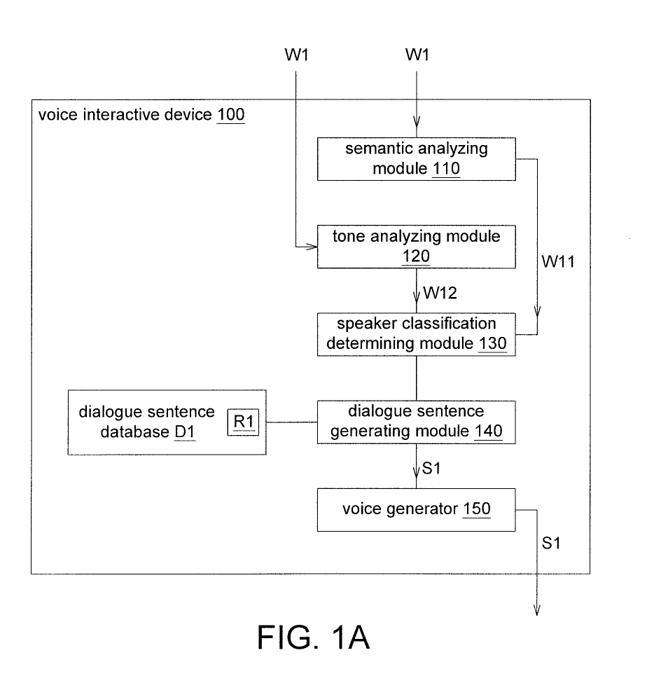

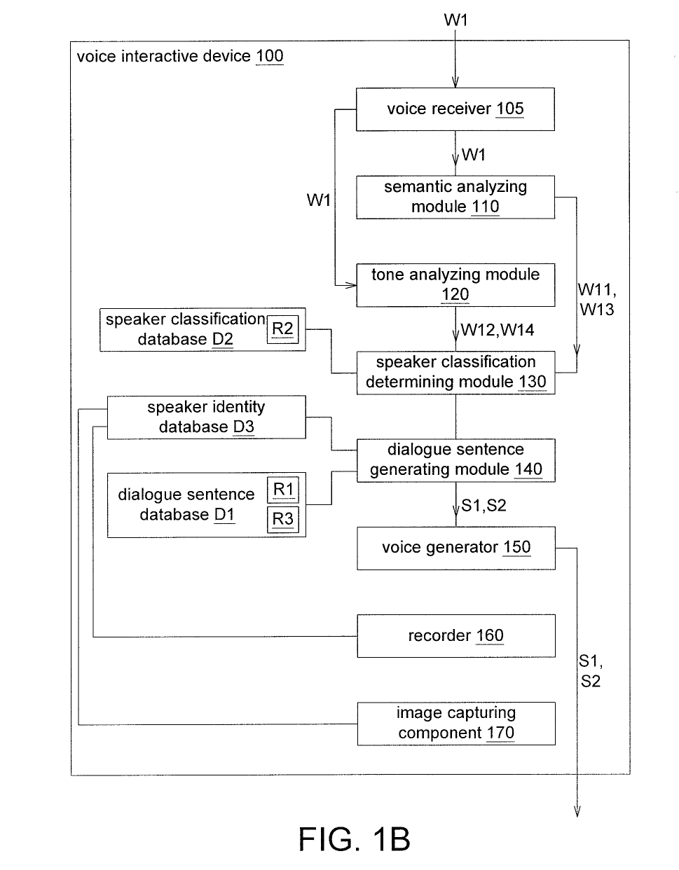

FIG. 1A illustrates a block diagram of a voice interactive device 100 according to an embodiment of the present invention. The voice interactive device 100 may analyze semantic meaning and tone of the speaking sentence from a speaker to determine that the speaker belongs to which one of a plurality of speaker classification types, and then may interact with (or respond to) the speaker. The voice interactive device 100 may be a robot, an electronic device or any form of computer.

The voice interactive device 100 includes a semantic analyzing module 110, a tone analyzing module 120, a speaker classification determining module 130, a dialogue sentence generating module 140, a voice generator 150 and a dialogue sentence database D1.

The semantic analyzing module 110, the tone analyzing module 120, the speaker classification determining module 130, the dialogue sentence generating module 140 and the voice generator 150 may be circuit structures formed by using semiconductor processes. In addition, the semantic analyzing module 110, the tone analyzing module 120, the speaker classification determining module 130, the dialogue sentence generating module 140 and the voice generator 150 may be independent structures, or at least two of them may be integrated into single structure. In some specific embodiments, at least two of these modules/components may also be implemented through a general-purpose processor/calculator/server in combination with other hardware (such as a storage unit).

The semantic analyzing module 110 is configured to analyze semantic meaning W11 of the speaking sentence W1. The tone analyzing module 120 is configured to analyze tone W12 of the speaking sentence W1.

The speaker classification determining module 130 may determine the semantic meaning W11 and the tone W12 of the speaking sentence W1 belong to which one of the speaker classification types C1. The dialogue sentence generating module 140 generates a response sentence S1 corresponding to the speaker classification type C1 of the speaker according to relationships R1 between speaker classification types and response sentences. The voice generator 150 outputs a response voice of the response sentence S1. Each relationship R1 includes a corresponding relationship between one speaker classification type C1 and one response sentence S1.

FIG. 1B illustrates a block diagram of the voice interactive device 100 according to another embodiment of the present invention. The voice interactive device 100 includes a voice receiver 105, the semantic analyzing module 110, the tone analyzing module 120, the speaker classification determining module 130, the dialogue sentence generating module 140, the voice generator 150 and recorder 160, an image capturing component 170, the dialogue sentence database D1, a speaker classification database D2 and a speaker identity database D3. The component names and reference numbers in FIG. 1B same as those in FIG. 1A have the same or similar functions, and details are not repeated herein. In addition, the voice receiver 105 is, for example, a microphone that may receive the speaker's speaking sentence W1. The recorder 160 may be, for example, a commercially available storage device or a built-in memory, while the image capturing component 170 may be, for example, commercially available video camera or photographic camera.

The speaker classification determining module 130 may determine that the semantic meaning W11 and the tone W12 of the speaking sentence W1 belong to which one of the speaker classification types C1 according to the relationships R2. Each relationship R2 includes a corresponding relationship between one set of the semantic meaning W11 and the tone W12 of the speaking sentence W1 to one speaker classification type C1. In addition, the relationships R2 may be stored in the speaker classification database D2.

The speaker of the present embodiment is, for example, a consumer. The speaker classification type C1 is, for example, a profile of consumer style. The profile of consumer style may be one of the following, such as brand-oriented type, emphasis on quality, emphasis on shopping fun, emphasis on popularity, regular purchase, emphasis on feeling, consideration type and economy type. The speaker classification types C1 of the consumer are not limited to these states, which may include other types. In addition, the embodiment of the present invention does not limit the number of the speaker classification types C1, and the number of the speaker classification types C1 may be less or more than the number of the foregoing types.

In an embodiment, the semantic analyzing module 110 may analyze the speaking sentence W1 to determine at least one keyword W13. The tone analyzing module 120 may analyze an emotion W14 of the speaker according to the tone W12. The speaker classification determining module 130 may determine that the speaker belongs to which one of the speaker classification types C1 according to the keyword W13 and the emotion W14. The above response sentence S1 may include the keyword W13. In addition, the tone analyzing module 120 may analyze sound velocity, voice frequency, timbre and volume of the speaking sentence W1 to determine the emotion W14 of the speaker. In some embodiments, at least one of sound velocity, voice frequency, timbre and volume of the speaking sentence W1 may be used to determine the emotion W14 of the speaker, for example, all of sound velocity, voice frequency, timbre and volume are used for determining the emotion W14 of the speaker.

In the example of the speaker being consumer, the keyword W13 is, for example, “cheap”, “price”, “rebate”, “discount”, “premium”, “promotion”, “deduction”, “bargain”, “now”, “immediately”, “hurry up”, “directly”, “wrap up”, “quickly”, “can not wait”, “previously”, “past”, “formerly”, “before”, “last time”, “last month”, “hesitation”, “want all”, “difficult to decide”, “feel well”, “choose”, “state”, “material”, “quality”, “practical”, “long life”, “durable”, “sturdy”, “trademarks (e.g. Sony, Apple, etc.), “company brand”, “brand”, “waterproof”, “outdoor”, “ride”, “travel”, “going abroad”, “popular”, “hot”, “limited”, “endorsement (e.g. exclusive eSports), Jay Chou endorsement, etc.”).

“Cheap”, “price”, “rebate”, “discount”, “premium”, “promotion”, “deduction” and “bargain” may be categorized as “brand-oriented type”. “now”, “immediately”, “hurry up”, “directly”, “wrap up”, “quickly”, “can not wait” may be categorized as “emphasis on quality”. “Previously”, “past”, “formerly”, “before”, “last time” and “last month” may be categorized as “regular purchase”. “Hesitation”, “want all”, “difficult to decide”, “feel well” and “choose” may be categorized as “consider the type”. “State”, “material”, “quality”, “practical”, “long life”, “durable” and “sturdy” may be categorized as “emphasis on quality”. “Trademarks”, “company brand” and “brand” may be categorized as “brand-oriented type”. “Waterproof”, “outdoor”, “ride”, “travel”, “going abroad” may be categorized as “emphasis on shopping fun”. “Popular”, “hot”, “limited” and “endorsement” may be categorized as “emphasis on popularity”.

In the example of the speaker being consumer, the emotion W14 is, for example, “delight”, “anger”, “sad”, “sarcasm” and “flat”. For example, as shown in Table 1 below, when the tone analyzing module 120 analyzes the tone W12 to determine a result of the sound velocity being slow, the voice frequency being low, the timbre being restless and the volume being small (that is, the first tonal feature of Table 1 below), it means the emotion W14 of the speaker is in a state of distressed and unable to decide, and thus the tone analyzing module 120 determines that the emotion W14 is “sad”. In addition, the embodiment of the present invention does not limit the type and/or quantity of the emotion W14. The quantity of the emotion W14 may increase according to the characteristics of more or other different tones W12.

TABLE 1

| features of the tone W12 | emotion W14 |
|---|---|
| sound velocity: slow; | distressed and unable to decide |
| voice frequency: low; | (sad) |
| timbre: restless; | |
| volume: small | |
| sound velocity: brisk; | excited, slightly expected |
| voice frequency: slightly high; | (delight) |
| timbre: pleased; | |
| volume: slightly large | |
| sound velocity: brisk; | happy, pleased (delight) |
| voice frequency: slightly high; | |
| timbre: pleased; | |
| volume: slightly large | |
| sound velocity: moderate; | unruffled, calm |
| voice frequency: moderate; | (ataraxy) |
| timbre: calm; | |
| volume: moderate | |
| sound velocity: sarcasm; | like these products |
| voice frequency: slightly high; | (delight) |
| timbre: pleased; | |
| volume: slightly large | |
| sound velocity: slow; | feel cheap and unreliable |
| voice frequency: slightly high; | (sarcasm) |
| timbre: cold attitude; | |
| volume: small | |
| sound velocity: Hurry; | unable to accept the price of the |
| voice frequency: high; | product (anger) |
| timbre: anxious; | |
| volume: large | |
| sound velocity: slow; | distressed and unable to decide |
| voice frequency: low; | (sad) |
| timbre: anxious; | |
| volume: small | |

In Table 1, “distressed and unable to decide” is, for example, categorized as “consideration type” (speaker classification type C1); “excited, slightly expected” is, for example, categorized as “economy type”; “happy, pleased” is, for example, categorized as “emphasis on feeling”; “unruffled” is, for example, categorized as “regular purchase”; “like these products” is, for example, categorized as “economy type”; “feel cheap and unreliable” is, for example, categorized as “emphasis on quality”; “unable to accept the price of the product” is, for example, categorized as “economy type”.

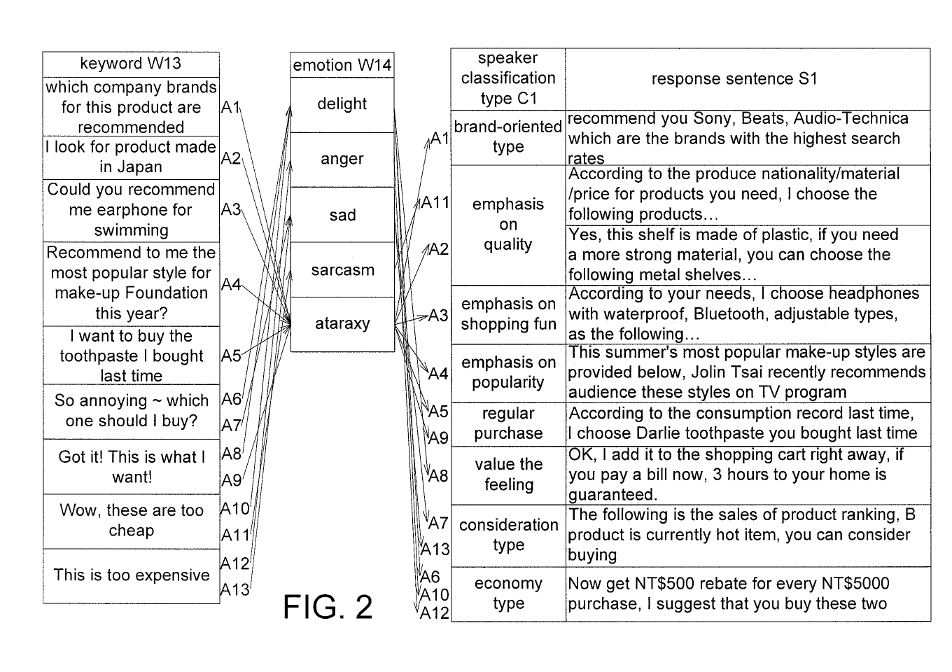

FIG. 2 illustrates a diagram of corresponding relationships among the keyword W13, the emotion W14, the speaker classification type C1 and the response sentence S1. When the speaking sentence W1 spoken by the speaker is “which company brands for this product are recommended”, the semantic analyzing module 110 analyzes the speaking sentence W13 to determine the keyword W13 is “company brand”, and the tone analyzing module 120 analyzes the emotion W14 to determine the emotion W14 is categorized as “ataraxy”. The speaker classification determining module 130 determines that the speaker belongs to “brand-oriented type” (speaker classification type C1) according to “company brand” (the keyword W13) and “ataraxy” (the emotion W14).

The dialogue sentence generating module 140 generates the response sentence S1 corresponding to “brand-oriented type” according to the relationships R1. For example, when the speaking sentence W1 is “which company brands for this product are recommended”, according to the speaker belonging to the “brand-oriented type”, the dialogue sentence generating module 140 generates the response sentence S1: “recommend you Sony, Beats, Audio-Technica which are the brands with the highest search rates”. The voice generator 150 output a corresponding response voice of the sentence S1. The voice generator 150 is, for example, a speaker. The response sentence S1 may include the same as or similar to meaning of the keyword W13. For example, the “brand” in the response sentence S1 is similar to the “company brand” of the keyword W13 of the speaking sentence W1. In another embodiment, the “brand” in the response sentence S1 may also be replaced by the “brand” of the keyword W13.

In another embodiment, when the semantic meaning W11 or the tone W12 can not be successfully analyzed, the dialogue sentence generating module 140 may generate a question S2, in which the question S2 is used to guide the speaker to increase more characteristic words in the speaking sentence W1. For example, when the semantic meaning W11 or the tone W12 can not be successfully analyzed, the dialogue sentence generating module 140 may generate the response sentence S1: “sorry, can you say it again” to prompt the speaker to say the speaking sentence W1 once again. Alternatively, when the semantic meaning W11 or the tone W12 can not be successfully analyzed, the dialogue sentence generating module 140 may generate response sentence S1: “Sorry, can you say it more clearly” to prompt the speaker to state more speaking sentence W1.

As described above, for the same speaking sentence W1, although they have the same semantic meaning W11, it is possible that the speaker belongs to different speaker classification type C1 depending on the emotion W14. Thus, the response sentence S1 is different accordingly. Furthermore, in addition to analyzing the semantic meaning W11 of the speaking sentence W1, the voice interactive device 100 further analyzes the tone W12 of the speaking sentence W1 to identify more accurately the speaker classification type C1 of the speaker and then generate the response sentence S1 corresponding to the speaker classification type C1 of the speaker. As a result, the voice interactive device 100 of the present embodiment can provide the speaker with product information quickly and stimulate the desire of the speaker's purchase through the voice interaction with the speaker.

In addition, the relationships R1 may be stored in the dialogue sentence database D1. In addition, the dialogue sentence database D1 may store a shopping list R3. When the speaking sentence W1 from the speaker includes the semantic meaning W11 related to the product, the dialogue sentence generating module 140 may generate the response sentence S1 according to the shopping list R3. The shopping list R3 includes, for example, complete information such as product name, brand, price, product description, etc., to satisfy most or all of the inquiries made by the speaker in the process of consumption.

In addition, after the speaker completes the consumption, the recorder 160 may record the speaker classification type C1 of the speaker, the consumer record of the speaker and the voiceprint of the speaking sentence W1 spoken by the speaker, and these information is recorded in the speaker identity database D3. The voiceprint may be used to identify the speaker's identity. Furthermore, in the subsequent analysis of the speaking sentence W1 of a certain speaker, the tone analyzing module 120 may compare the voiceprint of the speaking sentence W1 from the certain speaker with the plurality of the voiceprints in the speaker identity database D3. If the voiceprint of the speaking sentence W1 of the certain speaker matches one of the voiceprints in the speaker identity database D3, the dialogue sentence generating module 140 generates the response sentence S1 corresponding to the speaker classification type C1 of the certain speaker according to the consumer record of the certain speaker recorded by the recorder 160. In other words, if the speaker has spoken to the voice interactive device 100, the voice interactive device 100 may analyze the speaker's consumption history record to accurately determine the speaker classification type C1 (such as a conventional product, a conventional company brand and/or acceptable price, etc.), wherein the speaker classification type C1 is included in the reference to generate the response sentence S1.

In another embodiment, the voice interactive device 100 further includes the camera 170. The camera 170 may capture an image of the speaker, such as a facial image, to recognize the speaker's identity. In other words, the voice interactive device 100 may recognize the speaker's identity more accurately according to the voiceprint of the speaking sentence W1 and the facial image captured by the camera 170. In another embodiment, the voice interactive device 100 may omit the camera 170.

In another embodiment, the speaker may also be a caregiver. In the example of the speaker being the caregiver, the speaker classification type C1 includes, for example, a mental state of caregiver, such as at least two of tired state, sick state, anger state, autistic state and normal state (e.g. state of being in a good mood). The speaker classification type C1 is not limited to these states, which may include other types of states. In addition, the embodiment of the present invention does not limit the number of the speaker classification types C1, and the number of the speaker classification types C1 may be less or more than the number of the foregoing states.

To sum up, the speaker may be the consumer or the caregiver, etc. Therefore, the voice interactive device 100 may be applied to stores, hospitals or home care environments, etc.

In the example of the speaker being the caregiver, in an embodiment, when the speaker says “I am so tired!”, the voice interactive device 100 determines that the speaker belongs to the “tired state” (speaker classification type C1) according to the same method as described above, and generates the response sentence S1: “Get up early today! I suggest you could take a nap, you need to set an alarm clock?” In another embodiment, when the speaker says “I'm so tired . . . ”, the voice interactive device 100 determines that the speaker belongs to “sick state” (speaker classification type C1) according to the same method as described above, and generates the response sentence S1: “It is recommended that you lie down. Do you need my help with contacting your relatives or health care workers, or providing you with medical information?” In other embodiments, when the speaker says “Do not bother me!”, the voice interactive device 100 determines that the speaker belongs to “anger state” (speaker classification type C1) according to the same method as mentioned above, and generates the response sentence S1: “OK, I am always waiting for your calling!” Alternatively, when the speaker says “Do not bother me . . . ”, the voice interactive device 100 determines that the speaker belongs to the “autistic state” (speaker classification type C1) according to the same method as mentioned above and generates the response sentence S1: “Do you want to talk with me, what can I do for you?”

In addition, the voice interactive device 100 has a learning function of artificial intelligence. As more speakers speaks to the voice interactive device 100, the voice interactive device 100 may constantly expand and correct the relationships R1 and the relationships R2 to more accurately determine the speaker classification type C1.

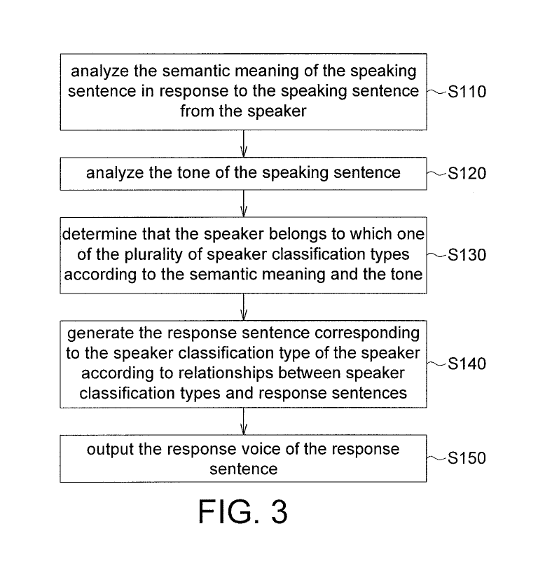

FIG. 3 illustrates a flowchart of a voice interactive process of FIG. 1B.

In step S110, the semantic analyzing module 110 analyzes the semantic meaning W11 of the speaking sentence W1 in response to the speaking sentence W1 from the speaker. In step S120, the tone analyzing module 120 analyzes the tone W12 of the speaking sentence W1. In step S130, the speaker classification determining module 130 determines that the speaker belongs to which one of the plurality of speaker classification types C1 according to the semantic meaning W11 and the tone W12. In step S140, the dialogue sentence generating module 140 generates the response sentence S1 corresponding to the speaker classification type C1 of the speaker according to relationships R1. In step S150, the voice generator 150 outputs the response voice of the response sentence S1 to speak to (or respond to) the speaker.

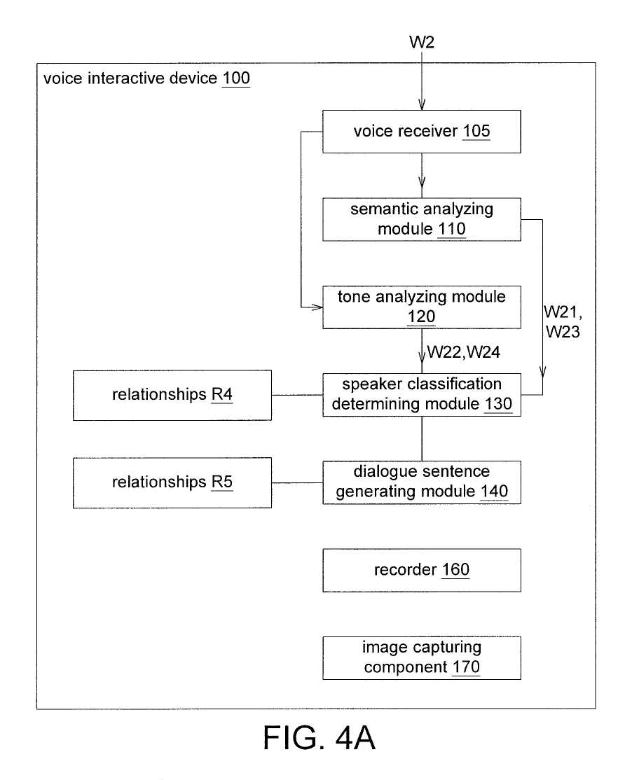

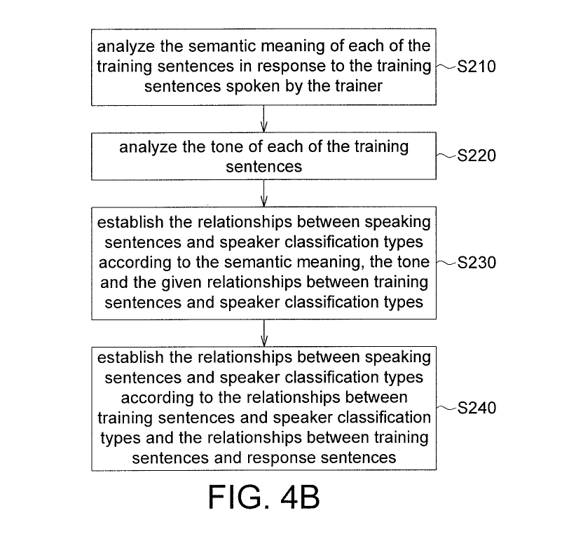

FIGS. 4A and 4B illustrate diagrams of voice training procedure of a training process of the voice interactive device 100 according to the present embodiment of the present invention.

Firstly, the voice receiver 105 receives a plurality of training sentences W2 spoken by a trainer. The training sentences W2 may be spoken by one or more trainers, which is not limited in the embodiment of the present invention.

Then, in step S210, the semantic analyzing module 110 analyzes the semantic meaning W21 of each of the training sentences W2 in response to the training sentences W2 spoken by the trainer. The semantic analyzing module 110 may analyze keyword W23 of the semantic meaning W21. The training sentence W2 may be the same as or similar to the speaking sentence W1 described above.

Then, in step S220, the tone analyzing module 120 analyzes tone W22 of each of the training sentences W2. For example, the tone analyzing module 120 may analyze emotion W24 of the tone W22 of each of the training sentences W2.

Then, in step S230, a plurality of given (or known) relationships R4 between training sentences and speaker classification types are pre-inputted to the voice interactive device 100, where each relationship R4 includes a corresponding relationship between one training sentence W2 and one speaker classification type C1. Then, the speaker classification determining module 130 establishes the relationships R2 according to the semantic meaning W21, the tone W22 and the given relationships R4. Then, the speaker classification determining module 130 stores the relationships R2 in the speaker classification database D2 (not illustrated in FIG. 4A). In an embodiment, the relationships R4 may be obtained through the analysis of the live situation.

Then, in step S240, the given relationships R5 between training sentences and response sentences are pre-inputted to the voice interactive device 100, wherein each relationship R5 includes a corresponding relationship between one training sentence W2 and one response sentence S1. Then, the dialogue sentence generating module 140 establishes the relationships R1 according to the relationships R4 and the relationships R5. Then, the dialogue sentence generating module 140 stores the relationship R1 to the dialogue sentence database D1 (not illustrated in FIG. 4A).

In an embodiment, the foregoing training process may be implemented by using Hidden Markov Model (HMM) algorithm, Gaussian mixture model (GMM) algorithm through K-means and/or a Deep Learning Recurrent Neural Network. However, such exemplification is not meant to be for limiting.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A voice interactive device, comprising:
a semantic analyzing module configured to analyze a semantic meaning of speaking sentence from a speaker;
a tone analyzing module configured to analyze a tone of the speaking sentence;
a speaker classification determining module configured to determine that the speaker belongs to one of a plurality of speaker classification types according to the semantic meaning and the tone;
a dialogue sentence database in which a plurality of relationships between speaker classifications and response sentences are stored;
a dialogue sentence generating module configured to generate a response sentence corresponding to the speaker according to the relationships between speaker classifications and response sentences; and
a voice generator configured to output a response voice of the response sentence.

2. The voice interactive device according to claim 1, wherein the semantic analyzing module is configured to analyze the speaking sentence to obtain a keyword, and the speaker classification determining module is configured to determine that the speaker belongs to the one of the speaker classification types according to the keyword and the tone.

3. The voice interactive device according to claim 2, wherein the response sentence comprises the keyword.

4. The voice interactive device according to claim 1, wherein the tone analyzing module is configured to analyze an emotion of the speaker according to the tone, and the speaker classification determining module is configured to determine that the speaker belongs to the one of the speaker classification types according to the semantic meaning and the emotion.

5. The voice interactive device according to claim 1, wherein each of the speaker classifications is a profile of consumer style.

6. The voice interactive device according to claim 5, wherein a shopping list is stored in the dialogue sentence database, and the dialogue sentence generating module is further configured to generate the response sentence according to the shopping list.

7. The voice interactive device according to claim 1, wherein each of the speaker classification types is a mental state of caregiver.

8. The voice interactive device according to claim 1, further comprising:
a recorder configured to record the one of the speaker classification types of the speaker, a consumer record of the speaker and a voiceprint.

9. The voice interactive device according to claim 1, wherein the dialogue sentence generating module is further configured to:
generate a question when the semantic meaning or the tone can't be successfully analyzed, wherein the question is for making the speaker increase more characteristic words in the speaking sentence.

10. The voice interactive device according to claim 1, wherein the dialogue sentence generating module is further configured to:
generate the response sentence corresponding to the speaker according to the one of the speaker classification types of the speaker, a consumer record of the speaker and a voiceprint recorded by a recorder.

11. A voice interactive method, comprising:
analyzing a semantic meaning of speaking sentence from a speaker;
analyzing a tone of the speaking sentence;
according to the semantic meaning and the tone, determining that the speak belongs to one of a plurality of speaker classification types; and
according to a plurality of relationships between the speaker classifications and response sentences stored in dialogue sentence database, generating a response sentence corresponding to the speaker; and
outputting a response voice of the response sentence.

12. The voice interactive method according to claim 11, further comprising:
analyze the speaking sentence to obtain a keyword; and
determining the speaker belongs to the one of the speaker classification types according to the keyword and the tone.

13. The voice interactive method according to claim 12, wherein the response sentence comprises the keyword.

14. The voice interactive method according to claim 11, further comprising:
analyzing an emotion of the speaker according to the tone; and
determining the speaker which one of the speaker classification types according to the semantic meaning and the emotion.

15. The voice interactive method according to claim 11, wherein each of the speaker classifications is a profile of consumer style.

16. The voice interactive method according to claim 15, wherein a shopping list is stored in the dialogue sentence database, and the voice interactive method further comprises:
generating the response sentence according to the shopping list.

17. The voice interactive method according to claim 11, wherein each of the speaker classification types is a mental state of caregiver.

18. The voice interactive method according to claim 11, further comprising:
recording the speaker classification type of the speaker, a consumer record of the speaker and a voiceprint.

19. The voice interactive method according to claim 11, further comprising:
generating a question when the semantic meaning or the tone can't be successfully analyzed, wherein the question is for making the speaker increase more characteristic words in the speaking sentence.

20. The voice interactive method according to claim 11, further comprising:
generating the response sentence corresponding to the speaker according to the speaker classification type of the speaker, a consumer record of the speaker and a voiceprint recorded by a recorder.

21. The voice interactive method according to claim 11, further comprising a training process, and the training process comprises:
response to a plurality of training sentences from a trainer, analyzing the semantic meaning of each training sentence;
analyzing the tone of each training sentence;
establishing a plurality of relationships between speaking sentences and speaker classification types according to the semantic meanings, the tones and a plurality of given relationships between training sentences and speaker classification types; and
establishing the relationships between speaker classification types and response sentences according to the given relationships between the training sentences and speaker classification types and a plurality of given relationships between training sentences and response sentences.
